(19) United States
(12) Patent Application Publication
(10) Pub. No.: US 2018/0100947 A1
(43) Pub. Date: Apr. 12, 2018

(54) SPECTRAL ANALYSIS OF SURFACE WAVES TO DETECT SUBSURFACE VOIDS

(71) Applicant: The Curators of the University of Missouri, Columbia, MO (US)

(72) Inventors: Payman Hajiani, Fresno, CA (US); Neil L. Anderson, Rolla, MO (US); J. David Rogers, Rolla, MO (US)

(73) Assignee: The Curators of the University of Missouri, Columbia, MO (US)

(21) Appl. No.: 15/722,711

(22) Filed: Oct. 2, 2017

Related U.S. Application Data
(60) Provisional application No. 62/405,075, filed on Oct. 6, 2016.

(51) Int. Cl. G01V 3/30; G01N 29/24; G01V 1/28

(52) U.S. Cl. CPC G01V 3/30; G01V 1/284; G01N 29/2462; G01N 29/2468

(57) ABSTRACT

Systems and methods for detecting a subsurface cavity. A source applies a force to ground under inspection and a plurality of sensors coupled to the ground detect resulting surface waves. A processor is configured to extract phase and frequency components of the acquired seismic data, identify a phase shift in surface waves in the ground under inspection based on the extracted phase and frequency components, and determine one or more physical characteristics of a subsurface cavity based on the identified phase shift.

### CROSS-REFERENCE TO RELATED APPLICATION

This application claims priority from U.S. Provisional Patent Application Ser. No. 62/405,075, filed Oct. 6, 2016, entitled “Spectral Analysis of Surface Waves to Detect Underground Openings.” The entire contents of the above-identified application are expressly incorporated herein by reference, including the contents and teachings of any references contained therein.

### BACKGROUND

Subsurface voids, underground cavities, and the like can be formed by natural processes such as karstification (e.g., dissolution of carbonate rocks) or by human activities (e.g., civil works, tunneling, and mining). Accurate and reliable detection of underground cavities is important for wide-ranging purposes, from engineering projects to homeland security. For example, every year subsurface voids cause ground subsidence, which can damage foundations, buildings, and public infrastructure. Several numerical and experimental studies have been undertaken to detect near-surface voids, including seismic refraction and ground penetrating radar. Surface waves have also been utilized to detect shallow subsurface voids. But each of the conventional nondestructive geophysical approaches has significant limitations and no single method has emerged that can be applied globally.

Multichannel analysis of surface waves (MASW) reveals anomalies in shear wave velocity occurring when a medium being profiled has significantly different elastic properties (e.g., air versus soil or air versus rock but not concrete versus soil). Longer wavelength surface waves are more sensitive to the elastic properties of deeper layers, whereas shorter wavelength surface waves are more sensitive to the elastic properties of shallow subsurface materials. In addition, surface waves are dispersive in an inhomogeneous medium. For these reasons, dispersive Love and Rayleigh surface waves yield useful information about the shallow subsurface. But MASW only analyzes the average shear wave velocity of different subsurface layers underneath the geophone spread and certain heterogeneities (e.g., a conduit or a culvert less than about 2 meters in diameter) may not exhibit anomalies on the shear wave profiles. And shear wave velocity profiles obtained by MASW do not provide useful information for detecting subsurface openings.

Conventional seismic refraction methods are only useful in layered media where the shear wave velocities of the layers increase with depth and density and are unable to distinguish “hidden layers,” where a layer of low velocity underlies a layer of higher velocity. This is a common situation with highway pavements, where the upper layer is of a higher density, while the aggregate base or subbase is of lower density and higher porosity. In such cases, where waves within the bottom layer are of lower velocity, head waves are not generated. Therefore, the method fails to detect near-surface voids.

A known numerical study, referred to as attenuation analysis of Rayleigh waves (AARW), locates subsurface tunnels and estimates their depths of embedment based on patterns of attenuation and amplification caused by constructive and destructive superposition of reflected surface waves from the voids. But conventional AARW is restricted to very shallow subsurface depths not exceeding more than about 1 meter. In addition, these techniques study signal amplitude, which attenuates quickly and, thus, fail to provide information on voids other than those very near the surface. And known Rayleigh wave diffraction methods cannot detect circular voids less than about 2 meters in diameter.

### SUMMARY

Briefly, aspects of the present invention utilize spectral analysis of surface waves to detect subsurface openings, such as pipes, culverts, tunnels, caverns, etc. based on time delays and anomalies in the phase spectrum domain.

In an aspect, a method of detecting a subsurface cavity includes acquiring seismic data from a plurality of sensors coupled to ground under inspection and extracting phase and frequency components of the acquired seismic data. The method further includes identifying a phase shift in surface waves in the ground under inspection based on the extracted phase and frequency components and determining one or more physical characteristics of a subsurface cavity based on the identified phase shift.

A system embodying aspects of the invention detects a subsurface cavity. The system includes a seismic source applying a force to ground under inspection and a plurality of sensors coupled to the ground. The system further includes a processor configured to execute computer-executable instructions for extracting phase and frequency components of the acquired seismic data, identifying a phase shift in surface waves in the ground under inspection based on the extracted phase and frequency components, and determining one or more physical characteristics of a subsurface cavity based on the identified phase shift.

In an aspect, a computing device includes a processor and a processor-readable storage device. The storage device has processor-executable instructions stored thereon that include instructions for acquiring seismic data from a plurality of sensors coupled to ground under inspection and extracting phase and frequency components of the acquired seismic data. The instructions also identify a phase shift in surface waves in the ground under inspection based on the extracted phase and frequency components and determine one or more physical characteristics of a subsurface cavity based on the identified phase shift.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating a test setup for detecting subsurface cavities according to an embodiment of the invention.

FIG. 2A is an exemplary flow diagram of method for detecting subsurface cavities according to an embodiment of the invention.

FIG. 2B is an exemplary flow diagram of method for detecting subsurface cavities according to an alternative embodiment of the invention.

FIGS. 3A and 3B are exemplary Normalized Energy Distance (NED) plots of seismic data acquired during subsurface cavity detection according to embodiments of the invention.

FIG. 4 is an exemplary NED plot of seismic data acquired during subsurface cavity detection according to another embodiment of the invention.

FIG. 5 is an exemplary power spectrum of seismic data acquired during subsurface cavity detection corresponding to FIG. 4.

FIG. 6 is an exemplary unwrapped phase spectrum of seismic data acquired during subsurface cavity detection according to an embodiment of the invention.

Corresponding reference characters indicate corresponding parts throughout the drawings.

### DETAILED DESCRIPTION

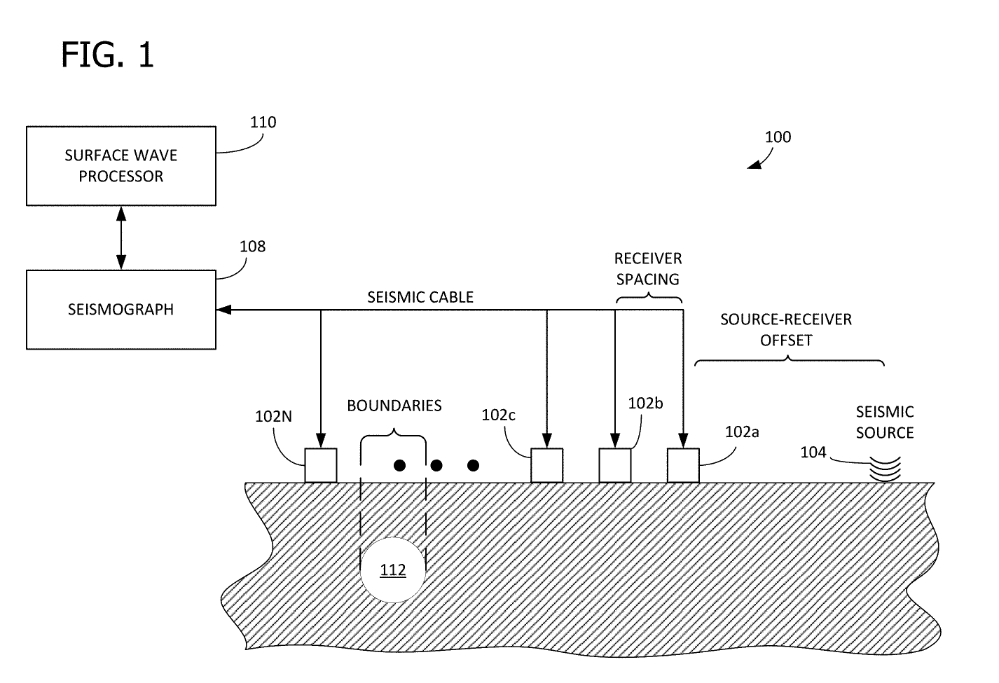

FIG. 1 is a block diagram schematically illustrating a system 100 for conducting a seismic survey according to an embodiment of the invention by performing a series of attenuation analyses on Love and/or Rayleigh surface waves. As shown, a plurality of receivers, or sensors, 102 provides multiple channels of seismic data in response to a source 104, which is a force applied to the ground under inspection. The sensors 102 are preferably arranged in a one-dimensional or two-dimensional array relative to the surface of the ground under inspection. A sledge hammer striking a metal plate, for example, delivers a source energy shot to transmit body waves, surface waves, etc. into the ground for generating seismic data. A multichannel seismograph 108 records the seismic data collected by the sensors 102 for processing by a surface wave processor 110 to detect subsurface voids or the like, such as void 112. In FIG. 1, individual sensors 102 are indicated by 102a, 102b, 102c, . . . , and 102N and it is to be understood that any number of sensors could be used depending on the capabilities of the seismograph 108. In an embodiment, the sensors 102 comprise different types of geophones (e.g., 100 Hz vertical, 14 Hz horizontal, and 14 Hz vertical) for use in evaluating the attenuation of surface waves in the ground under inspection based on AARW. An RAS24™ seismograph available from Seistronix is suitable for use as seismograph 108.

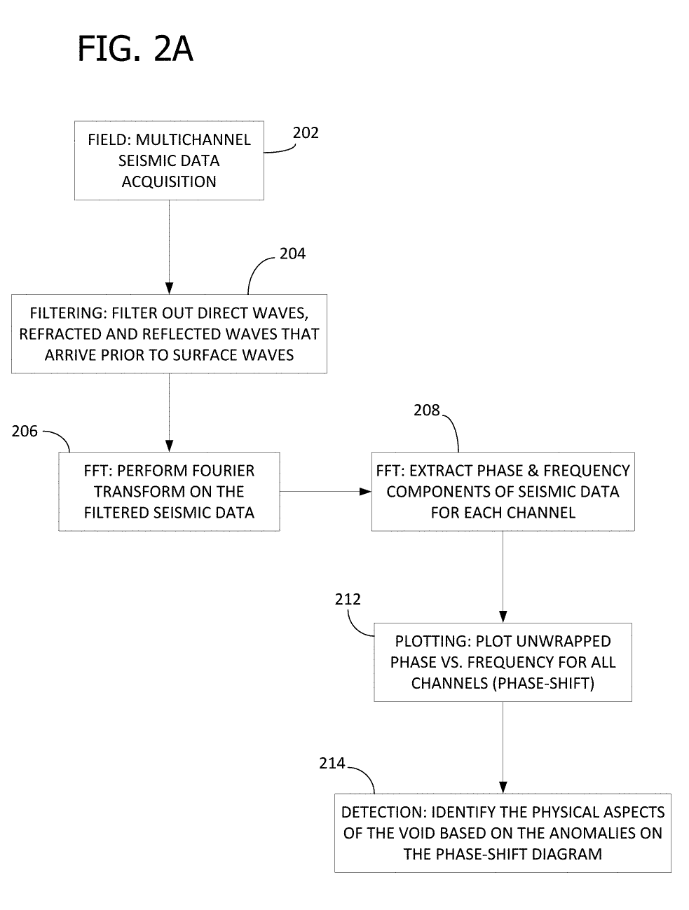

FIG. 2A illustrates an exemplary workflow according to aspects of the present disclosure for performing a time delay method of detecting subsurface voids. Beginning at 202, the plurality of sensors 102 provides multiple channels of seismic data to seismograph 108 in response to a force applied in the field to the ground under inspection at source 104. Proceeding to 204, the processor 110 filters out one or more of direct waves, refracted waves, and reflected waves that arrive prior to the surface waves. In this manner, the seismic data for processing is limited to surface waves. Rayleigh surface waves, for example, do not propagate through air-filled voids because the shear modulus for air is zero. By the same token, the phase spectrum domain could be expected to be exposed to some disturbance caused by energy transmitted around the void in the proximity of the underground openings. As a consequence, a time delay in Rayleigh waves occurs where an air-filled void is present and, based on dispersion characteristics of surface waves, only certain frequencies of surface waves may penetrate to the depth where void 112 exists. A phase shift (time delay) can be observed in the proximity of the location of the void in the phase spectrum domain. In addition, reflection of seismic waves from the culvert interface causes a disturbance in the phase-frequency spectra. The reason is that when certain frequencies of the Rayleigh waves penetrate to the depth of the underground opening, they interact with the opening's physical boundaries. At this juncture, some portion of the incident waves reflect back to the medium, while other portions are diffracted and transmitted. The reflected waves superpose with the incident waves. The wave interactions can be constructive or destructive, leading to a shift in amplitudes and phases. Those skilled in the art recognize these regions of amplification and attenuation between the source and the air-filled void. Aspects of the present invention permit detecting significant anomalies on the phase spectrum domains near the locations of subsurface pipes or tunnels, such as void 112.

At 206, processor 110 performs Fourier transforms on the filtered seismic data to extract phase and frequency components for each channel at 208. In an embodiment, NED parameters are calculated for each channel, according to:

NEDᵢ=Eᵢ/max(Eᵢ) (1)

where Eᵢ is the cumulative signal energy at geophone station i (sensor 102i), namely, the summation of the amplitude squared of all the frequency components for each geophone station:

Eᵢ=Σ_{f=1}^{N}|A_{f}|² (2)

where A_{f} is the amplitude of the frequency component f, and the frequency spectrum is comprised of N frequency components.

According to equation (1), the cumulative energy is normalized to the maximum energy recorded across all of the sensors 102. To better examine the attenuation of surface waves due to the existence of underground voids, such as void 112, a gain function is applied across an array of channels to compensate for geometrical damping. The surface wave processor 110 applies these processing steps to Love and/or Rayleigh wave data sets.

By plotting unwrapped phase vs. frequency information for all of the channels at 212, system 100 permits identifying physical aspects of the underground cavity (void 112) at 214 based on the anomalies on the phase shift diagram. Each of the sensors 102 comprises a channel and plotting the extracted phase and frequency components relative to each other for each of the channels permits identification of one or more anomalies in the phase shift. The phase information and the frequency information are plotted for each channel independent of other channels but on the same plot such that relative anomalies compared to neighboring sensors (geophones) can be readily identified. The horizontal locations of the channels on the ground experiencing anomalous phase spectrum reveals the horizontal location of the cavity and the empirical relationship between the frequency of the surface waves to the depth that the wave has penetrated reveals the vertical location of the cavity.

FIG. 2B illustrates another exemplary workflow according to aspects of the present disclosure for performing a time delay method of detecting subsurface voids. Beginning at 216, multichannel seismic data is acquired and then processed at 220 to filter out one or more of direct waves, refracted waves, and reflected waves that arrive prior to surface waves. At 222, Fourier transforms are performed on the filtered seismic data to extract phase and frequency components for each channel at 224. At 228, the frequency spectrum is divided into small bands in order to identify the frequency bands experiencing time delay. By plotting unwrapped phase vs. frequency information for all of the channels at 230, the illustrated time delay method permits identifying physical aspects of the underground cavity 112 at 232 based on the anomalies observed on the phase shift diagram.

In an embodiment, performing multichannel seismic surveys at multiple locations with differing site characteristics (e.g., on asphalt concrete pavement above a reinforced cement concrete (RCC) box culvert or on an earthen dam above a circular RCC culvert having differing depths of overburden) demonstrates successful detection of underground voids 112.

Referring again to FIG. 1, the block diagram illustrates an exemplary test configuration for performing spectral analysis of surface waves to detect underground openings at relatively deep depths of up to, for example, 3 meters. In an embodiment, the ground under inspection is asphalt concrete pavement and void 112 is an RCC box culvert. In another embodiment, the ground under inspection is soil and void 112 is a circular RCC culvert having a conduit comprising a spillway outfall for an embankment dam. Seismic data is acquired using multichannel receivers for use in MASW. The wave-field in this embodiment is Fourier transformed from the time domain to frequency domain. The frequency and phase spectra of the wave field is then derived. The effects of the presence of void 112 are studied on the phase spectra. Significant anomalies are seen on the phase spectra plots where the subsurface voids exist.

### Example: Experimental Data Acquisition and Method

In this example, sensors 102 comprise three sets of geophones: vertical 14 Hz, horizontal 14 Hz, and vertical 100 Hz. Shear source 104 (e.g., a sledge hammer strike) generates Love surface waves.

In a first experiment, 20 horizontal geophones (14 Hz) are deployed on the ground under inspection to acquire the Love waves. The geophones axes are set perpendicular to the geophone array. The vertical distance between the survey line and the top of the culvert (void 112) is, in this experiment, 3.8 m for both vertical and horizontal 14 Hz geophone surveys. The spacing between geophones is 0.6 m, and source 104 comprises a 9 kg sledgehammer discharged upon a metallic plate energy source. The multichannel seismograph 108 (e.g., RAS-24™) records 20 channels of seismic data from the geophones (sensors 102). The surveys are performed with different source-receiver offsets (e.g., 1.5 m, 3.0 m, and 6.0 m) for comparison purposes. Reverse shot gathers are acquired as well. In an embodiment, three to five shots are collected at each source location and seismic traces are vertically stacked to suppress the incoherent noise recorded by the array. The geophone arrays are positioned across the axis of the buried culvert (void 112) (in this instance, located between channels 10 and 11). For the reverse shot gathers, the geophones remain in place, while the energy source is positioned on the opposite end of the array, with the same source-receiver offsets.

Similar experiments are performed with vertical geophones (14 Hz and 100 Hz). The geometry of the surveys for the 14 Hz vertical and horizontal geophones is held constant. However, for the 100 Hz vertical geophones, 24 geophone stations spaced apart by 30 cm are employed.

Following data acquisition, processor 110 processes the seismic data according to, for example, the AARW technique to study the attenuation characteristics of Rayleigh and Love waves. Before applying the AARW technique, a velocity filter is applied on the shot gathers in an embodiment to remove the direct P-waves, refracted waves, reflection, and air waves. The reason for removing these signals is because surface waves attenuate faster than body waves at large offsets. As such, applying the velocity filter increases the signal-to-noise ratio at larger offsets. Generally, surface waves are identified on the seismic profiles by their relatively low velocities, lower frequencies, higher amplitudes, and dispersive characteristics.

According to the AARW technique, processor 110 performs a Discrete Fourier Transform (DFT) on the time series (shot gathers), and the frequency amplitudes of the signals are thereby acquired. Carrying out phase shift analyses on the 100 Hz vertical geophone data sets permits studying the changes in the time delays for the surface waves. Time delays are expected due to the presence of subsurface voids. Shear-waves do not propagate in voids, so the average velocity of the surface waves decreases where the void exists underground. Accordingly, the phase information can be extracted from the frequency domain. Then, the phase shifts are unwrapped and plotted as a function of frequency. Changes in the slope of phase shift versus frequency indicate time delays in signal arrivals. In an embodiment, the collected data is filtered so that only surface waves are retained in time domain, which is suitable for determining the time delay in propagation of the surface waves due to presence of subsurface voids. In other words, the seismic events rather than surface waves are filtered, based on their arrival time and amplitudes. Surface waves have higher amplitudes and lower velocities compared to body waves, which makes it easy to identify the surface waves on the seismic profiles.

Advantageously, aspects of the present invention permit a new approach to detect the location of subsurface culverts, tunnels, or other voids by extracting and unwrapping the phase spectra corresponding to the frequency components of the wave field. Group delay (time delay) is defined as the negative of the derivative of the phase-response with respect to frequency and is measured in radians/Hz.

### Example: Experimental Results

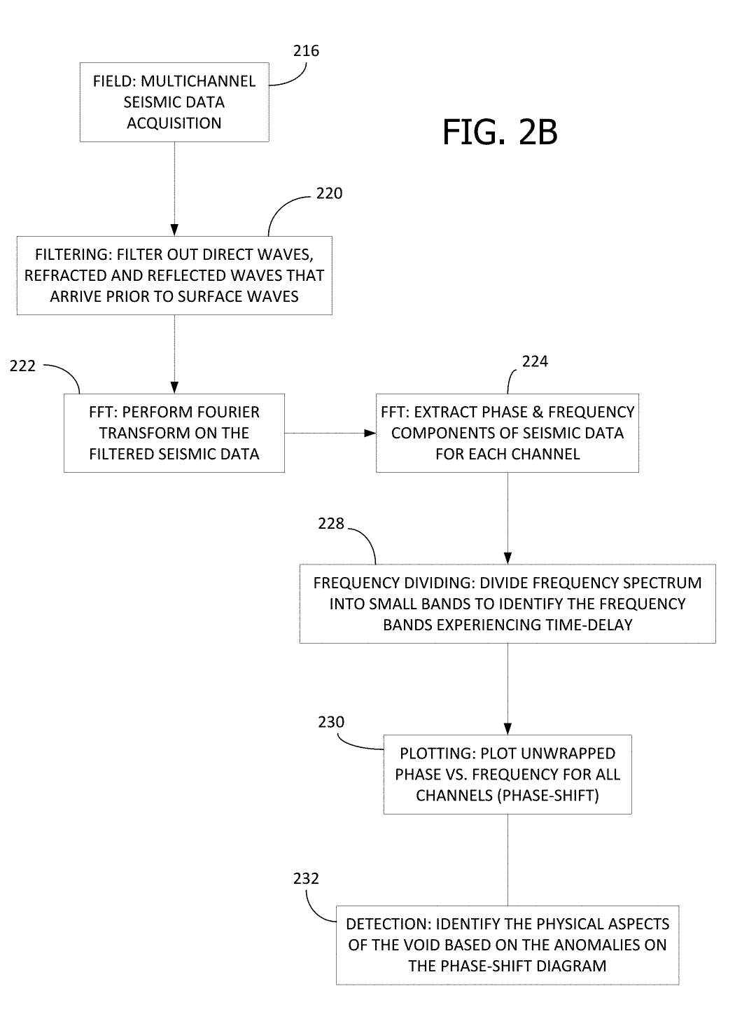

FIGS. 3A and 3B illustrate exemplary results of known attenuation analyses plotted for the vertical and horizontal 14 Hz geophones, respectively. FIG. 3A displays the NED plot for a 20-channel system recording of the Love waves. The source-receiver offset is 3 m in this embodiment to the right of the last sensor 102 in the array (i.e., geophone station number 20). FIG. 3A shows the marked attenuation of the Love waves where a subsurface void 112 (e.g., a culvert or tunnel) is present. The locations of the near and far boundaries of void 112 are shown by arrows (culvert boundaries under the ground). Although the Love wave energy decreases with increasing the distance from the energy source, a sudden increase in the energy of the Love wave can be seen (FIG. 3A), beginning in front of the near boundary of the culvert. Channels 12 and 11 (the source 104 in this instance is located to the right of the array) indicate an increment in the Love wave energy. A decline in the energy of the Love waves is observed following the far boundary of the culvert.

FIG. 3B illustrates exemplary NED values plotted for the Rayleigh waves. The same attenuation trend can be seen for the Rayleigh waves. The energy decreases with distance from the source, but an anomaly in the energy is clearly observable in front of the near boundary of the culvert.

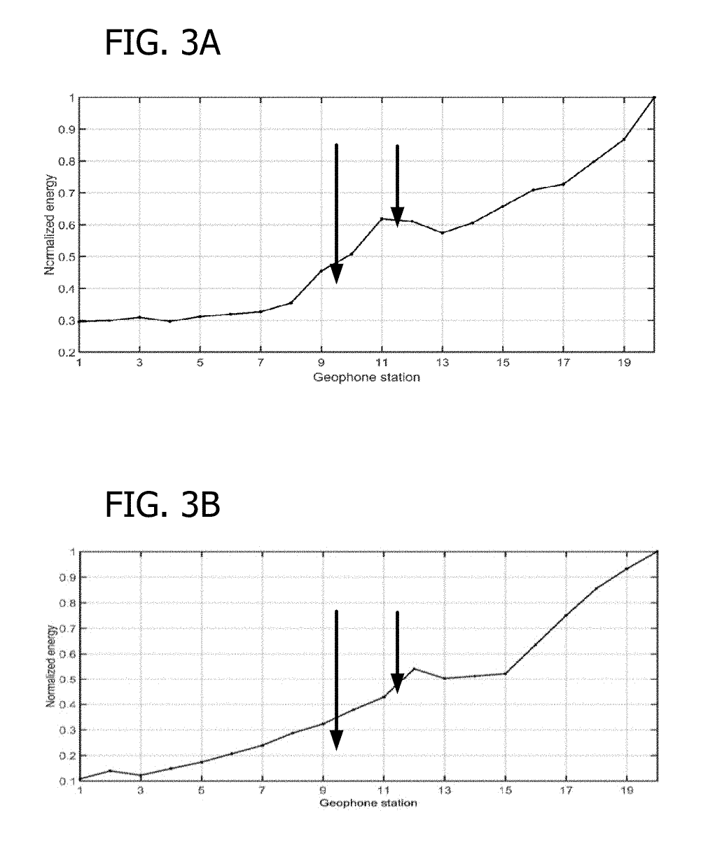

FIG. 4 shows the exemplary results of a known attenuation analysis for the vertical 100 Hz geophone experiment. In this instance, the culvert embedment depth in this survey is 1.5 m. The source is located 1.5 m west of the first sensor 102. In FIG. 4, the peak for the NED occurs right in front of the near boundary of the culvert on channel 5 (the wave is propagating from west to east). Some small ripples in the calculated NEDs are also observed on channels 13 to 17. The attenuation analyses of the Rayleigh waves with the higher frequency geophones of 100 Hz indicate a more pronounced anomaly in the NED values.

The exemplary data presented in FIGS. 3A, 3B, and 4 indicate the peak energy occurs in front of a near boundary of void 112. These energy peaks occur due to the reflection of the seismic energy from the interface of different media (i.e., soil or concrete versus air-filled void).

The Love wave experiments (FIG. 3A) exhibit a slightly more pronounced anomaly in the NED values than the Rayleigh waves (FIG. 3B) for the 14 Hz experiments. It is important to note that during data acquisition, consistent impact forces are applied to generate both Love and Rayleigh waves. However, generating a smooth impact source for the Love waves is challenging due to the use of impact shear force (hand-held hammer). A mechanical energy source is contemplated.

For the 100 Hz experiment, the attenuation anomaly of the Rayleigh waves is more pronounced (FIG. 4). In the 100 Hz experiment, the source 104 is intentionally set closer to the first sensors 102 (e.g., 1.5 m) because the higher frequencies generally attenuate faster than lower frequencies. One reason that the peak of the energy for the NED on FIG. 4 is more pronounced than the peak of energy in either FIG. 3A or FIG. 3B is that the depth from the array to the top of the culvert is shallower (1.5 m) than the other two surveys (3.8 m). Therefore, less attenuation occurs before the scattered surface waves (off of the culvert boundary) reach the sensors 102.

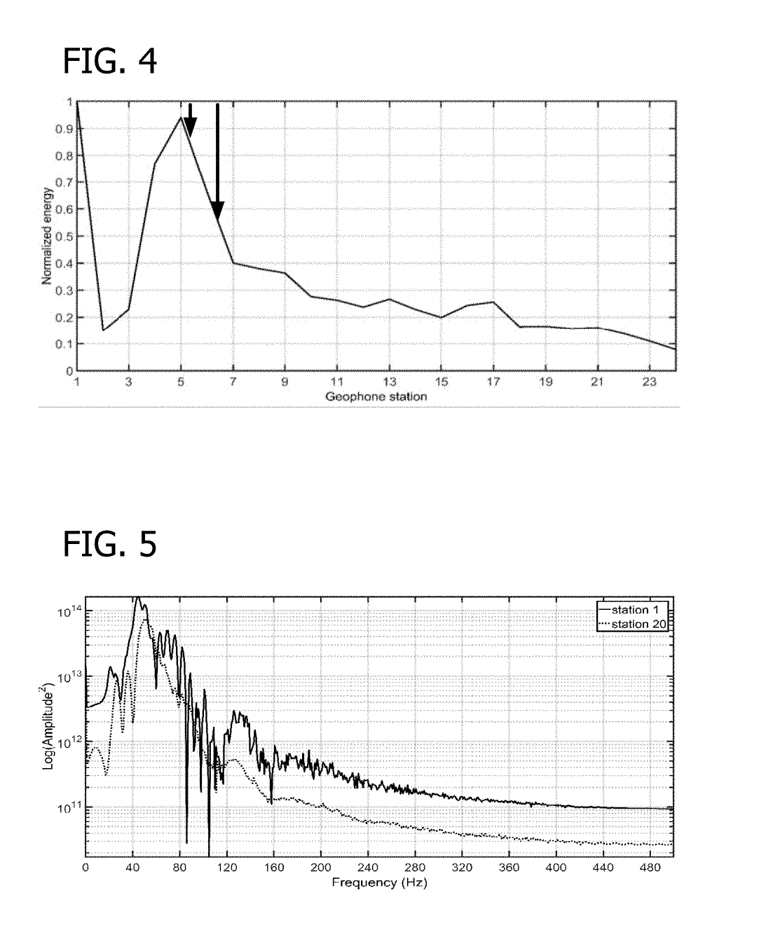

FIG. 5 illustrates exemplary power spectra (frequency amplitude squared for each frequency spectrum) for stations 1 and 20 of the 100 Hz geophones (sensors 102). As understood by one skilled in the art, the plot indicates how surface waves at higher frequencies attenuate considerably more than surfaces waves at lower frequencies. In addition, FIG. 5 shows that the highest frequencies recorded in this experiment are between 40 Hz and 50 Hz. Note the two spikes in the power spectra at frequencies of 85 Hz and 105 Hz for station 1, which are absent at station 20.

FIG. 5 shows the power spectra at stations 1 and 20 for the 100 Hz experiment and confirms that surface waves at higher frequencies attenuate more quickly than surface waves at lower frequencies. The large volume of noise on the power spectra plot at the first station is likely due to bouncing of the sledge hammer after the first strike on the source plate (data acquisition issue). The spikes are of high frequencies (85 Hz and 105 Hz), and are absent on the last geophone station. These types of noises attenuate quickly with distance.

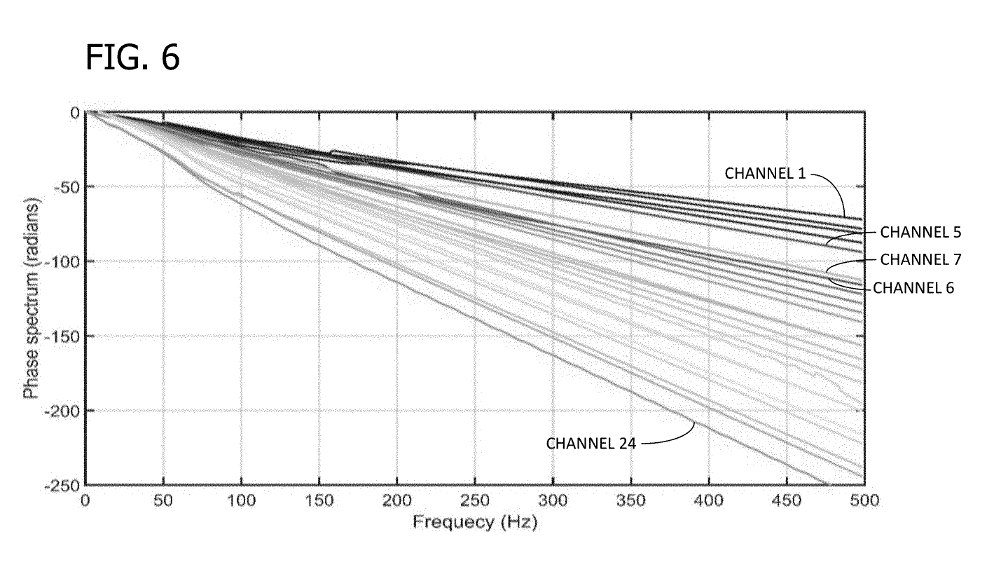

According to aspects of the invention, phase shift spectra are then calculated as a function of frequency as shown in FIG. 6. Exemplary phase shifts for each of the channels 1 thru 24 are shown. The increasingly negative slope of the phase shifts in the spectra with respect to the frequency is indicative of “time delay.” FIG. 6 displays the time delays for the arrivals of the vertical component of the Rayleigh waves. It can be appreciated that the slopes of each channel changed constantly and slowly, indicating the arrival time of the Rayleigh waves at each station. However, channels 5 and 6 exhibit anomalies in the slope of the phase shifts, ranging from 140 Hz to 170 Hz, with a larger time delay for channel 6 (indicating greater changes in the dip for the phase shift between those frequencies at channel 6). Channels 5 and 6 highlight the observed phase shifts. Frequencies of higher than 200 Hz demonstrate healing (e.g., the slopes of the phase shifts are more or less equal for channels 5 and 6 at frequencies higher than 200 Hz). Moreover, the phase shift of channel 7 intercepts channel 6 at 160 Hz with a less dip. The turning points for the phase shift in channel 6 occur at 160 Hz and 210 Hz (wave healing).

The phase spectra corresponding to the frequency components of the wave field are extracted and unwrapped in MATLAB™. MATLAB™ unwraps the phase spectrum for jumps of equal to or greater than π for consecutive elements in the frequency domain, which it adds in multiples of 2π. The resolution of the frequency relates to the total recording time, and the highest frequency that can be resolved (Nyquist frequency) in the frequency domain is related to the time sample rate in the time domain.

FIG. 6 summarizes the phase shift analysis for the 100 Hz experiment. Because surface waves are dispersive, different wavelengths (frequencies) penetrate to different depths in the subsurface. Therefore, not all the frequencies are disturbed by the presence of the air-filled voids. The results in FIG. 6 indicate that the air-filled culvert (void 112) caused a delay in the arrival times of specific frequencies, in the range of 140 Hz to 170 Hz.

Surface waves cannot propagate, theoretically, through air-filled voids. The shear modulus of the air and water is zero, so Love waves and the shear wave component of the Rayleigh waves cannot propagate through voids, such as subsurface void 112. Consequently, it is expected that a time delay would be observed in vicinity of subsurface voids. FIG. 6 indicates such a time delay occurs in the location of the buried culvert. On the other hand, these wavelengths are much greater or much shorter than the diameter and depth of the culvert. That is why wave healing can be seen on either side of the anomaly ranges (i.e., waves are healed outside the range of 140 Hz to 170 Hz).

As described above, the acquired data represents three sets of seismic experiments carried out over a buried concrete culvert to evaluate attenuation analyses and time delay analyses of Love and Rayleigh waves and indicate that the combination of the attenuation analysis and the time delay analysis can effectively detect subsurface voids up to several meters deep (e.g., up to 4 m depth of cover). The time delay in surface arrivals occur because the shear waves do not propagate in voids and, therefore, result in a lower average velocity of the surface waves in the presence of subsurface voids.

Aspects of the present invention permit detecting near surface underground voids based on the phase spectrum domain. A change in the slope of the phase versus frequency denotes a time delay. Since the shear modulus for air is zero, Rayleigh waves do not propagate through air-filled voids. Therefore, a time delay can be discerned on the phase spectrum domain. The process of muting the body waves which arrive before the surface waves is necessary to ensure that only the surface waves will interact with the void's boundaries. In other words, only the effects of the voids are being evaluated on the propagation of the surface waves.

Dispersive characteristics of the Rayleigh waves ensure that different frequency (wavelength) propagate at different depths. Therefore, certain frequencies interact with the voids, basically according to depth of penetration for those frequencies. The application of time delay on the surface waves is a useful technique for detecting near-surface voids, pipes, culverts, or tunnels when the AARW technique cannot identify the deeper voids.

Embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may include a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, solid state drives (SSDs), magnetic cassettes, magnetic tape, magnetic disk storage or other magnetic storage devices, or any other medium which can be used to store the desired non-transitory information, which can be accessed by the computer. Alternatively, communication media typically embody computer readable instructions, data structures, program modules or other data in a modulated data signal such as a carrier wave or other transport mechanism and includes any information delivery media.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, processor-executable instructions are stored in a memory, such as the hard disk drive, and executed by the computer. Advantageously, the computer processor has the capability to perform all operations (e.g., execute processor-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with processor-executable instructions. The processor-executable instructions may be organized into one or more processor-executable components or modules. Aspects of the disclosure may be implemented with any number and organization of such components or modules. For example, aspects of the disclosure are not limited to the specific processor-executable instructions or the specific components or modules illustrated in the figures and described herein. Other embodiments may include different processor-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for detecting a subsurface cavity comprising:
a seismic source applying a force to ground under inspection;
a plurality of sensors coupled to the ground; and
a surface wave processor configured to execute computer-executable instructions for:
extracting phase and frequency components of the acquired seismic data;
identifying a phase shift in surface waves in the ground under inspection based on the extracted phase and frequency components; and
determining one or more physical characteristics of a subsurface cavity based on the identified phase shift.

2. The system of claim 1, wherein the seismic source is positioned within a predetermined distance of the sensors to generate the surface waves in the ground.

3. The system of claim 1, wherein the plurality of sensors comprises an array of geophones.

4. The system of claim 1, wherein the computer-executable instructions for identifying the phase shift in the surface waves comprise instructions for filtering the seismic data to remove data corresponding to one or more of direct waves, refractions, reflections, and ambient noise.

5. The system of claim 1, wherein the computer-executable instructions for extracting the phase and frequency components comprise instructions for performing a Fourier transform on the seismic data.

6. The system of claim 5, wherein transformed frequency components of the seismic data comprise a frequency spectrum and wherein the computer-executable instructions further comprise instructions for dividing the frequency spectrum into bands to identify the bands experiencing time delay.

7. The system of claim 1, wherein each of the sensors comprises a channel and wherein the computer-executable instructions further comprise instructions for plotting the extracted phase and frequency components relative to each other for each of the channels to identify one or more anomalies in the phase shift.

8. The system of claim 7, wherein the one or more physical characteristics of a subsurface cavity is based on the identified anomalies in the phase shift.

9. A method of detecting a subsurface cavity comprising:
acquiring seismic data from a plurality of sensors coupled to ground under inspection;
extracting phase and frequency components of the acquired seismic data;
identifying a phase shift in surface waves in the ground under inspection based on the extracted phase and frequency components; and
determining one or more physical characteristics of a subsurface cavity based on the identified phase shift.

10. The method of claim 9, further comprising applying a force to the ground within a predetermined distance of the sensors to generate the surface waves in the ground.

11. The method of claim 9, wherein the plurality of sensors comprises an array of geophones.

12. The method of claim 9, wherein identifying the phase shift in the surface waves comprises filtering the seismic data to remove data corresponding to one or more of direct waves, refractions, reflections, and ambient noise.

13. The method of claim 9, wherein extracting the phase and frequency components comprises performing a Fourier transform on the seismic data.

14. The method of claim 13, wherein transformed frequency components of the seismic data comprise a frequency spectrum and further comprising dividing the frequency spectrum into bands to identify the bands experiencing time delay.

15. The method of claim 9, wherein each of the sensors comprises a channel and further comprising plotting the extracted phase and frequency components relative to each other for each of the channels to identify one or more anomalies in the phase shift.

16. The method of claim 15, wherein determining the one or more physical characteristics of a subsurface cavity is based on the identified anomalies in the phase shift.

17. A computing device comprising:
a surface wave processor; and
a processor-readable storage device having processor-executable instructions stored thereon including instructions that, when executed by the processor:
acquire seismic data from a plurality of sensors coupled to ground under inspection;
extract phase and frequency components of the acquired seismic data;
identify a phase shift in surface waves in the ground under inspection based on the extracted phase and frequency components; and
determine one or more physical characteristics of a subsurface cavity based on the identified phase shift.

18. The computing device of claim 16, wherein the processor-executable instructions for identifying the phase shift in the surface waves comprise instructions for filtering the seismic data to remove data corresponding to one or more of direct waves, refractions, reflections, and ambient noise.

19. The computing device of claim 17, wherein the processor-executable instructions for extracting the phase and frequency components comprise instructions for performing a Fourier transform on the seismic data.

20. The computing device of claim 17, wherein each of the sensors comprises a channel and wherein the processor-executable instructions comprise instructions for plotting the extracted phase and frequency components relative to each other for each of the channels to identify one or more anomalies in the phase shift and determining the one or more physical characteristics of a subsurface cavity is based on the identified anomalies in the phase shift.
